(19) United States
(12) Patent Application Publication
(10) Pub. No.: US 2005/0245687 A1
(43) Pub. Date: Nov. 3, 2005

(54) Multimodal polyethylene extrusion

(76) Inventors: Marvin R. Appel, Loveland, OH (US); Brian A. Wolfe, Cincinnati, OH (US)

Correspondence Address: LYONDELL CHEMICAL COMPANY, 3801 WEST CHESTER PIKE, NEWTOWN SQUARE, PA, 19073, US

(21) Appl. No.: 10/836,889

(22) Filed: Apr. 30, 2004

(51) Int. Cl. C08L 27/12

(52) U.S. Cl. 525/199

(57) ABSTRACT

A method for reducing die buildup for multimodal polyethylene extrusion is disclosed. The method comprises extruding a mixture comprising a fluorine-containing polymer, an antioxidant, and a multimodal polyethylene passing a die wherein the fluorine-containing polymer and the antioxidant are present in effective amounts to reduce die buildup.

### FIELD OF THE INVENTION

The invention relates to polyethylene extrusion. More particularly, the invention relates to reduction of die buildup in polyethylene extrusion.

### BACKGROUND OF THE INVENTION

Die buildup means accumulation of polymers, usually low molecular weight polymers, around the extrusion die. Die buildup may result in inconsistent performance of the polyethylene film. Die buildup may also cause degradation of the polymer due to the prolonged heating around the die. The degraded polymer buildup can be pulled from the die as the film is extruded, resulting in black or brown spots in the film that can cause failure in film performance and is aesthetically unpleasing.

It is believed that low molecular polymers cause die buildup. Low molecular weight polymers can be generated during extrusion by polymer degradation under high temperature and high shear; therefore, adding antioxidants into polyethylene can often reduce die buildup. For instance, U.S. Pat. No. 6,156,421 discloses that using hindered phenol, such as α-tocopherol, can reduce die buildup in polymer extrusion.

It is also known to the polyolefin industry that fluorocarbon polymers can improve the extrudability of polyethylene. For instance, U.S. Pat. No. 4,740,341 discloses that adding a fluorocarbon polymer, such as polyvinylidene fluoride, can reduce melt fracture, head pressure, and extruder power of linear low density polyethylene (LLDPE).

Similarly, U.S. Pat. No. 6,642,310 discloses the improvement of extrusion processability of polyethylene by introducing a fluoropolymer which has an average particle size greater than 2 microns. According to the patent disclosure, such fluoropolymers have improvements particularly with polyethylenes having high molecular weight and narrow molecular weight distribution.

Multimodal polyethylenes are known. “Multimodal” means that two or more peak molecular weights can be seen by gel permeation chromatography (GPC). For example, a bimodal polyethylene means that two peak molecular weights can be identified. Multimodal polyethylene can be transformed into articles by injection molding, blow molding, rotational molding, and film extrusion. One of the advantages of multimodal polyethylene over mono-modal polyethylene is easier and faster processing with a reduced energy requirement and increased output. In addition, multimodal polyethylenes show less flow disturbances in thermal processing.

However, multimodal polyethylenes often represent a unique die buildup problem. Unlike high molecular weight, mono-modal polyethylene extrusion, die buildup in multimodal polyethylene extrusion often cannot be sufficiently reduced or eliminated by adding an antioxidant. This is partly because multimodal polyethylene inherently contains some low molecular weight polymer that causes die buildup. Antioxidants, although helpful in reducing die buildup by preventing polyethylene from degradation and forming low molecular weight polymers, are not sufficiently effective in the reduction of die buildup in multimodal polyethylene extrusion.

In conclusion, new methods for reducing die buildup in multimodal polyethylene extrusion are needed. Ideally, the method uses readily available extrusion processing aids.

### SUMMARY OF THE INVENTION

The invention is a method for reducing the die buildup in multimodal polyethylene extrusion process. Die buildup means accumulation of polymers, usually low molecular weight polymers, around the extrusion die lip. Die buildup is also called die lip buildup.

The method comprises incorporating a fluorine-containing polymer and an antioxidant into a multimodal polyethylene and extruding the polyethylene passing a die. The fluorine-containing polymer and the antioxidant are used in amounts effective to reduce or eliminate die buildup.

Multimodal polyethylenes often represent a unique die buildup problem. Unlike die buildup in high molecular weight, mono-modal polyethylene extrusion, the die buildup in multimodal polyethylene extrusion cannot be effectively reduced or eliminated by adding either an antioxidant or a fluoropolymer. This is partly because the multimodal polyethylene inherently contains low molecular weight polymers that cause the die buildup. Antioxidants, although helpful in reducing die buildup by preventing polyethylene from degradation, are not sufficiently effective in reducing die buildup in multimodal polyethylene extrusion.

The method of the invention provides an effective way to reduce or eliminate die buildup in multimodal polyethylene extrusion. It can be used for blown film extrusion, blow molding, and many other processes which involve extruding a multimodal polyethylene.

### DETAILED DESCRIPTION OF THE INVENTION

Fluorine-containing polymers useful in the invention include homopolymers and copolymers derived from any fluorine-containing monomers. Examples of fluorine-containing monomers include vinylidene fluoride, vinyl fluoride, hexafluoropropylene, tetrafluoroethylene, chlorotrifluoroethylene, the like, and mixtures thereof.

The fluorine-containing polymers include copolymers of fluorine-containing monomers and fluorine-free comonomers. Examples of fluorine-free comonomers include ethylene, propylene, 1-butene, 1-hexene, the like, and mixtures thereof. Examples of the fluorine-containing copolymers are poly(ethylene-co-tetrafluoroethylene), poly(tetrafluoroethylene-co-propylene), poly(chlorotrifluoroethylene-co-ethylene), and poly(ethylene-co-tetrafluoroethylene-co-hexafluoropropylene).

Many fluorine-containing polymers and copolymers are taught, for example, by U.S. Pat. Nos. 6,451,925, 4,740,341, and 3,125,547, the teachings of which are herein incorporated by reference. Many florine-containing polymers are commercially available; examples are Dynamar™ FX 5911 from Dyneon and Viton® FreeFlow™ Z200 from Dupont Dow Elastomers.

Preferably, the fluorine-containing polymer is an elastomeric fluoropolymer or so-called fluoroelastomer. Fluoroelastomers are fluoropolymers which have a glass transition temperature (Tg) below room temperature and which exhibit little or no crystallinity at room temperature. Fluoroelastomers are disclosed, for example, by U.S. Pat. No. 6,642,310, the teachings of which are incorporated herein by reference. Examples of suitable fluoroelastomers are vinylidene fluoride/hexafluoropropylene copolymers, vinylidene fluoride/chlorotrifluoroethylene copolymers, vinylidene fluoride/1-hydropentafluoropropylene copolymers, and vinylidene fluoride/2-hydropentafluoropropylene copolymers, the like, and mixtures thereof.

Preferably, the fluorine-containing polymer has a weight average particle size less than or equal to 10 microns. More preferably, the weight average particle size of fluorine-containing polymer is within the range of 2 microns to 10 microns. Preparation of small particle fluorine-containing polymers is also taught by U.S. Pat. No. 6,642,310, the teachings of which are herein incorporated by reference.

Suitable antioxidants useful for the invention include those known to the polymer industry. Examples of suitable antioxidants are hindered phenolic compounds, hindered amines, thiocarbamates, thioesters, phosphites, and mixtures thereof. Antioxidants are often divided into primary and secondary antioxidants. Primary antioxidants (such as hindered phenolic compounds) can effectively terminate free radicals, while secondary antioxidants (such as thioesters) function as peroxide decomposers.

Hindered phenolic antioxidants are preferred. Examples of hindered phenolic antioxidants are pentaerythritol tetrakis (3-(3,5-di-tert butyl-4-hydroxyphenyl)propionate), octadecyl-3-(3,5-di-tert butyl-4-hydroxyphenyl) propionate, and 1,3,5-trimethyl-2,4,6-tris(3,5-di-tert-4-hydroxybenzyl) benzene. Suitable antioxidants include those which are commercially available from Ciba Specialty Chemicals under the tradenames IRGANOX and IRGAFOS.

By “multimodal polyethylene,” we mean any polyethylene which has a multimodal molecular weight distribution. In other words, the polyethylene has more than one molecular weight peaks on GPC (gel permeation chromatography) curve.

Suitable multimodal polyethylene includes high density polyethylene (HDPE), medium density polyethylene (MDPE), low density polyethylene (LDPE), and linear low density polyethylene (LLDPE). HDPE has a density of 0.941 g/cm³ or greater; MDPE has density from 0.926 to 0.940 g/cm³; and LDPE or LLDPE has a density from 0.910 to 0.925 g/cm³. See ASTM D4976-98: Standard Specification for Polyethylene Plastic Molding and Extrusion Materials. Preferably, the multimodal polyethylene is an HDPE. Density is measured according to ASTM D1505.

Preferably, the multimodal polyethylene is a bimodal polyethylene. By “bimodal,” we mean that the polyethylene has two molecular weight peaks on GPC curve. Preferably, the lower molecular weight component (corresponding to the lower molecular weight peak on GPC) has a melt index (MI₂) within the range of 10 dg/min to 750 dg/min, more preferably from 50 dg/min to 500 dg/min, and most preferably from 50 dg/min to 250 dg/min. Preferably, the higher molecular weight component (corresponding to the higher molecular weight peak on GPC) has an MI₂ within the range of 0.005 dg/min to 0.25 dg/min, more preferably from 0.01 dg/min to 0.25 dg/min, and most preferably from 0.01 dg/min to 0.15 dg/min. MI₂ is measured according to ASTM D-1238. In general, lower MI₂ means higher molecular weight.

Preferably, the lower molecular weight component has a higher density than the higher molecular weight component. Preferably, the lower molecular weight component has a density within the range of 0.925 g/cm³ to 0.970 g/cm³, more preferably from 0.938 g/cm³ to 0.965 g/cm³, and most preferably from 0.940 g/cm³ to 0.965 g/cm³. Preferably, the higher molecular weight component has a density within the range of 0.865 g/cm³ to 0.945 g/cm³, more preferably from 0.915 g/cm³ to 0.945 g/cm³, and most preferably from 0.915 g/cm³ to 0.940 g/cm³.

Preferably, the bimodal polyethylene has a lower molecular weight component/higher molecular weight component weight ratio within the range of 10/90 to 90/10, more preferably from 20/80 to 80/20, and most preferably 35/65 to 65/35.

Suitable multimodal polyethylene preferably has a weight average molecular weight (Mw) within the range of 50,000 to 500,000. More preferably, the Mw is within the range of 100,000 to 250,000. Most preferably, the Mw is within the range of 150,000 to 250,000. Preferably, the multimodal polyethylene has a number average molecular weight (Mn) within the range of 10,000 to 100,000, more preferably from 10,000 to 50,000. Preferably, the multimodal polyethylene has a molecular weight distribution (Mw/Mn) greater than about 8, more preferably greater than about 10, and most preferably greater than about 15.

The Mw, Mn and Mw/Mn are obtained by gel permeation chromatography (GPC) on a Waters GPC2000CV high temperature instrument equipped with a mixed bed GPC column (Polymer Labs mixed B-LS) and 1,2,4-trichlorobenzene (TCB) as the mobile phase. The mobile phase is used at a nominal flow rate of 1.0 mL/min and a temperature of 145° C. No antioxidant is added to the mobile phase, but 800 ppm BHT is added to the solvent used for sample dissolution. Polymer samples are heated at 175° C. for two hours with gentle agitation every 30 minutes. Injection volume is 100 microliters.

The Mw and Mn are calculated using the cumulative matching % calibration procedure employed by the Waters Millennium 4.0 software. This involves first generating a calibration curve using narrow polystyrene standards (PSS, products of Waters Corporation), then developing a polyethylene calibration by the Universal Calibration procedure.

Suitable multimodal polyethylene can be made by blending a higher molecular weight polyethylene with a lower molecular weight polyethylene. Alternatively, suitable bimodal polyethylene can be made by a multiple reactor process. The multiple reactor process can use either sequential multiple reactors or parallel multiple reactors, or a combination of both. For instance, a bimodal polyethylene can be made by a sequential two-reactor process which comprises making a lower molecular weight component in a first reactor, transferring the lower molecular weight component to a second reactor, and making a higher molecular weight component in the second reactor. The two components are blended in-situ in the second reactor.

Alternatively, a bimodal polyethylene can be made by a parallel two-reactor process which comprises making a lower molecular weight component in a first reactor and making a higher molecular weight component in a second reactor, and blending the components in a mixer. The mixer can be a third reactor, a mixing tank, or an extruder.

Methods for making multimodal polyethylene are known. For instance, U.S. Pat. No. 6,486,270, the teachings of which are herein incorporated by reference, teaches the preparation of a multimodal polyethylene by a multiple reactor process. According to the patent, changing polymerization conditions such as hydrogen concentration, α-olefin comonomer concentration, and reaction temperatures can vary the molecular weights of the polymers made in different reactors and result in a multimodal polyethylene.

Multiple catalyst systems can be used to make multimodal polyethylene. For instance, U.S. Pat. No. 6,127,484, the teachings of which are incorporated herein by reference, teaches a multiple catalyst process. A single-site catalyst is used in a first stage or reactor, and a Ziegler-Natta catalyst is used in a later stage or a second reactor. The single-site catalyst produces a polyethylene having a lower molecular weight, and the Ziegler-Natta catalyst produces a polyethylene having a higher molecular weight. Therefore, the multiple catalyst system can produce bimodal or multimodal polymers.

The multimodal polyethylene, fluorine-containing polymer, and antioxidant are mixed by any suitable ways. They can be mixed in solution or in thermal blending. Thermal blending, e.g., extrusion, is preferred because no solvent is used. Optionally, an acid scavenger is added to the mixture. Suitable acid scavengers are known to the polyolefin industry; examples are calcium stearate, zinc stearate, and mixtures thereof.

The fluorine-containing polymers and the antioxidants are used in amounts effective to reduce die buildup during an extrusion process of the multimodal polyethylene. Preferably, the mixture contains less than 1,000 ppm of the fluorine-containing polymer. More preferably, the mixture contains less than 500 ppm of the fluorine-containing polymer. Most preferably, the mixture contains from 100 ppm to 500 ppm of the fluorine-containing polymer. Preferably, the mixture contains less than 5,000 ppm of the antioxidants. More preferably, the mixture contains less than 2,000 ppm of the antioxidants. Most preferably, the mixture contains from 500 ppm to 2,000 ppm of the antioxidants.

The following examples merely illustrate the invention. Those skilled in the art will recognize many variations that are within the spirit of the invention and scope of the claims.

### COMPARATIVE EXAMPLE 1

A commercial bimodal, high density polyethylene (density: 0.949 g/cm³, melt index (MI₂): 0.057 dg/min, Mn: 12,600, Mw: 212,000, and Mw/Mn: 16.8, product of Equistar Chemicals, LP) is mixed with 800 ppm Irganox 1010 (product of Ciba Specialty Chemicals, as primary antioxidant), 800 ppm Irgafos 168 (product of Ciba Specialty Chemicals, as secondary antioxidant), 750 ppm calcium stearate (as an acid scavenger), 750 ppm zinc stearate (as an acid scavenger). The mixture is blended on a Coperion ZSK-30 mm which is an intermission co-rotating bi-lobe twin screw extruder. The screw speed is 200 RPM. The extruder temperature is from 145° C. to 215° C. The extrusion is under nitrogen purge.

Die buildup on a blown film process is approximated by the use of a capillary die, allowing for photographic analysis of the die buildup. The resin is extruded on a Killion S/N 11674 1″ Extruder with a capillary die attached to the screen changer/adapter. The resin is extruded at a rate of 6-7 pph at screw speeds of 60 RPM. The melt temperature varies between 271° C. and 280° C. The head pressure varies between 2150 and 2550 psig. Photographs of the die are taken for the Optical Image Analysis (OIA) from a fixed position at regular time intervals. The OIA is performed using a software Image-Pro Plus v4.5.1.22 by Media Cybernetics, Inc. The software calculates the area of die buildup shown in the photograph for ½ the die circumference. The value is then used as a reference of die buildup for the following examples.

### EXAMPLE 2

Example 1 is repeated, but the bimodal polyethylene is mixed with 100 ppm of a fluoropolymer (Viton® FreeFlow™ Z200, product of Dupont Dow Elastomers), 800 ppm Irganox 1010, 800 ppm Irgafos 168, and 500 ppm calcium stearate. No zinc stearate is used. Photographs of the die are taken from the same position at the same time intervals as in Comparative Example 1. The OIA is performed and the die buildup value is compared with the reference value of Comparative Example 1, which show about 50% reduction in die buildup. The % reduction in die buildup is calculated by dividing the difference between the die buildup value of the current example and the reference value by the reference value.

### EXAMPLE 3

Example 2 is repeated, but 150 ppm of Z200 is used. The % reduction in die buildup is about 50% compared to the reference value of Comparative Example 1.

### EXAMPLE 4

Example 1 is repeated, but the bimodal polyethylene is mixed with 300 ppm of a fluoropolymer (Dynamar™ Polymer Processing Additive FX5911, product of Dyneon), 800 ppm Irganox 1010, 800 ppm Irgafos 168, and 500 ppm calcium stearate. No zinc stearate is used. The % reduction in die buildup is about 100%, which means that the die buildup is essentially eliminated.

### COMPARATIVE EXAMPLE 5

Example 4 is repeated, but only 200 ppm of FX5911 is used. The % reduction in die buildup is about 0%, which means that there is essentially no die buildup reduction.

### COMPARATIVE EXAMPLE 6

Example 4 is repeated, but only 100 ppm of FX5911 is used. The % reduction in die buildup is about 0%, which means that there is essentially no die buildup reduction.

1. A method comprising extruding a mixture comprising a multimodal polyethylene, a fluorine-containing polymer, and an antioxidant, wherein the fluorine-containing polymer and the antioxidant are present in amounts effective to reduce die buildup.

2. The method of claim 1 wherein the mixture contains less than 1000 ppm of the fluorine-containing polymer.

3. The method of claim 1 wherein the mixture contains less than 500 ppm of the fluorine-containing polymer.

4. The method of claim 1 wherein the mixture contains from 100 ppm to 500 ppm of the fluorine-containing polymer.

5. The method of claim 1 wherein the fluorine-containing polymer contains monomeric units selected from the group consisting of tetrafluoroethylene, vinylidene fluoride, hexafluoropropylene, and mixtures thereof.

6. The method of claim 1 wherein the antioxidant is a hindered phenolic compound.

7. The method of claim 1 wherein the mixture contains less than 5,000 ppm of the antioxidant.

8. The method of claim 1 wherein the mixture contains less than 2,000 ppm of the antioxidant.

9. The method of claim 1 wherein the mixture further comprises an acid scavenger.

10. The method of claim 9 wherein the acid scavenger is selected from the group consisting of zinc stearate, calcium stearate, and mixtures thereof.

11. The method of claim 1 wherein the multimodal polyethylene comprises a lower molecular weight component having a melt index (MI₂) within the range of 10 dg/min to 750 dg/min and a higher molecular weight component having an MI₂ within the range of 0.005 dg/min to 0.25 dg/min.

12. The method of claim 11 wherein the multimodal polyethylene has a lower molecular weight component/higher molecular weight component weight ratio within the range of 10/90 to 90/10.

13. The method of claim 11 wherein the lower molecular weight component has a density within the range of 0.925 g/cm³ to 0.970 g/cm³ and the higher molecular weight component has a density within the range of 0.865 g/cm³ to 0.945 g/cm³.

14. The method of claim 11 wherein the multimodal polyethylene is made by a process which comprises making a lower molecular weight component in a first reactor, transferring the lower molecular weight component to a second reactor, and making a high molecular weight component and blending it in-situ with the lower molecular weight component in the second reactor.

15. The method of claim 11 wherein the multimodal polyethylene is made by a process which comprises making a lower molecular weight component in a first reactor and making a higher molecular weight component in a second reactor, and blending the components.

16. A composition comprising a multimodal polyethylene, a fluorine-containing polymer, and an antioxidant.

17. The composition of claim 16 wherein the fluorine-containing polymer and the antioxidant are present in amounts effective to reduce die buildup in a die extrusion process.

18. The composition of claim 16 wherein the multimodal polyethylene has a molecular weight distribution greater than about 10.

19. The composition of claim 16 containing from 100 ppm to 500 ppm of the fluorine-containing polymer and from 500 ppm to 5,000 ppm of the antioxidant.

20. The composition of claim 16 wherein the fluorine-containing polymer contains monomeric units selected from the group consisting of tetrafluoroethylene, vinylidene fluoride, hexafluoropropylene, and mixtures thereof.

21. The composition of claim 1 wherein the antioxidant is a hindered phenolic compound.
